(19) United States
(12) Patent Application Publication
(10) Pub. No.: US 2026/0328955 A1
(43) Pub. Date: Oct. 22, 2026

(54) Multi-sample Radioactive Decay-Based Neutron Irradiator for Neutron Activation Analysis

(71) Applicant: Massachusetts Institute of Technology, Cambridge, MA (US)

(72) Inventors: Livia Fernandes Barros, Boston, MA (US); Haruko M. Wainwright, Belmont, MA (US); Michael Philip Short, Cambridge, MA (US); Tolga Durak, Marblehead, MA (US); Edward A. Lamere, Walpole, MA (US); Mitchell S. Galanek, Plymouth, MA (US)

(21) Appl. No.: 19/241,880

(22) Filed: Jun. 18, 2025

Related U.S. Application Data
(60) Provisional application No. 63/662,317, filed on Jun. 20, 2024.
(60) Provisional application No. 63/724,083, filed on Nov. 22, 2024.

(51) Int. Cl. G01T 3/00; G21G 4/02

(52) U.S. Cl. CPC G01T 3/001; G21G 4/02

(57) ABSTRACT

A radioactive decay-based neutron irradiator method, system, and apparatus improves precision, safety, and efficiency in Neutron Activation Analysis (NAA). The irradiator apparatus employs an optimized shielding and neutron moderation design minimizing worker dose (exposure). The irradiator accommodates multiple samples for simultaneous irradiation in a radially symmetric placement that maximizes neutron utilization and minimizes residence time for high-throughput NAA.

### RELATED APPLICATIONS

This application claims the benefit of U.S. Provisional Application No. 63/662,317, filed on Jun. 20, 2024; and U.S. Provisional Application No. 63/724,083, filed on Nov. 22, 2024. The entire teachings of the above applications are incorporated herein by reference.

### BACKGROUND

Neutron Activation Analysis (NAA) is an analytical technique of high sensitivity, excellent precision and accuracy, and suitable for multi-element quantitative analysis. It can handle a small amount of solid or properly contained liquid samples to measure certain trace elemental concentrations without the need for chemical dissolution and separation. Thus, it has great promise for simplifying some medical screening procedures, rendering them much less invasive, as well as automating and simplifying some environmental measurements.

### SUMMARY

An embodiment relates to a radioactive decay-based neutron irradiation specimen measurement system. The system includes an irradiator, the irradiator has a housing formed of walls including at least one layer of shielding and a moderator, such that the walls effectively minimize radiation exposure external to the housing. The housing may contain a neutron source, that may be positioned within the housing in a manner providing simultaneous irradiation of multiple test samples. Additionally, the measurement system includes a mechanism that automates association of the test samples with respective data from each of different stages of a Neutron Activation Analysis (NAA) of the test samples including stages of irradiation by the irradiator and detection by a detector. For a given test sample of the multiple test samples, the mechanism automates (i) tracking of identification of the given sample, and (ii) as generated by the different stages of the NAA, attributing to the given sample physical characteristics and NAA spectra parameters such that the mechanism enables output of an indication of elemental composition of the given sample determined by the NAA of the given test sample. The system further includes an output interface communicatively coupled to the mechanism that provides indications of concentration of elements in respective elemental composition of test samples determined by the NAA of the multiple test samples.

In an embodiment, the irradiator is top loading, and the housing is a cylindrical or nearly cylindrical (polygon of at least five sides) container where (i) the at least one layer of shielding is formed of a combination of high neutron absorption materials and high neutron moderation materials (lead or boron-contained materials, generally herein "BCM") and has an inner diameter of about 5cm – 150cm, the at least one layer of shielding having a thickness between the inner diameter and an outer diameter of at least about 18cm – 59cm, and (ii) the moderator is formed of a combination of high neutron moderation materials and high-density moderation materials. In one embodiment, the at least one layer of shielding is formed of a PVC (polyvinyl chloride) composite impregnated with boron to achieve both of these goals, as a non-limiting example. In one or more embodiments, the moderator is formed of high-density polyethylene, as a non-limiting example.

A further embodiment includes a shielded neutron source shipping container located within the housing and containing the neutron source. The shielded neutron source shipping container has walls formed of a first cylindrical or nearly axisymmetric, polygonal layer formed of a combination of relatively low neutron absorption materials and high neutron moderation materials, and a second cylindrical layer formed of polyvinyl chloride (PVC), or a similar material. The first cylindrical layer being concentric to the second cylindrical layer such that in cross section an outer diameter of the second cylindrical layer directly abuts an inner diameter of the first cylindrical layer, and an inner diameter of the second cylindrical layer constrains a volume of air.

Another embodiment includes a port for loading the multiple test samples into the housing, the port being located atop the housing.

In an embodiment, the multiple test samples are in a radially symmetric, or nearly radially symmetric, geometry in relation to the neutron source, the geometry enabling maximum neutron utilization and minimum residence time for high throughput NAA.

In another embodiment, the mechanism further enables output indications of respective gamma spectrum for test samples.

In an embodiment, the output indications are void of protected personally identifiable information, the mechanism applying anonymizing or equivalent techniques to the output data and indications.

In an embodiment, the output indications include information useful for determining activity relating to a donor of one of the multiple test samples.

In another embodiment, the mechanism includes time-stamping the multiple test samples at the different stages of the NAA.

Another embodiment includes a feedback algorithm, using online gamma spectra, configured to determine when an appropriate signal to noise ratio for each of the multiple test samples has been achieved.

In an embodiment, the neutron source comprises one or more isotopes configured to produce neutrons by at least one of a direct radioactive decay mechanism (such as spontaneous fission), or at least one isotope configured to induce a separate at least one isotope to emit neutrons by a radioactive decay mechanism (such as (n,2n) neutron multiplication).

In an embodiment, the neutron source is Californium isotope ²⁵²Cf.

Other system configurations (such as housing shape and geometries), dimensions, and materials are suitable and in the purview of one skilled in the art given this disclosure.

Another embodiment is directed toward a radioactive decay-based neutron irradiator apparatus, for non-limiting example a Californium neutron irradiator apparatus. The apparatus includes a cylindrical housing formed of walls and containing a neutron source. The neutron source is positioned within the cylindrical housing in a manner providing simultaneous irradiation of multiple test samples, the walls of the cylindrical housing effectively minimize radiation exposure external to the housing. The walls include (i) at least one layer of shielding formed of a combination of high neutron absorption materials and high neutron moderation materials (BCM) that has an inner diameter of about 5cm – 150cm, the at least one layer of shielding has a thickness between the inner diameter and an outer diameter of at least about 18cm – 59cm. The walls further include (ii) a moderator formed of a combination of high neutron moderation materials and high-density moderation materials.

The apparatus further includes a shielded neutron source shipping container having walls formed of (i) a first cylindrical or nearly axisymmetric, polygonal layer formed of a combination of low neutron absorption materials and high neutron moderation materials, and (ii) a second cylindrical layer formed of polyvinyl chloride (PVC), or a similar material. The first cylindrical layer is concentric to the second cylindrical layer such that in cross section an outer diameter of the second cylindrical layer directly abuts an inner diameter of the first cylindrical layer, and an inner diameter of the second cylindrical layer constrains a volume of air.

An embodiment includes a port for loading the multiple test samples into the housing, the port being located atop the housing.

In an embodiment, the multiple test samples are in a radially symmetric, or nearly radially symmetric, geometry in relation to the neutron source, the geometry is configured to enable maximum neutron utilization and minimum residence time for high throughput NAA.

In an embodiment the multiple test samples are prepared with a mechanism that automates association of the test samples with respective data from each of different stages of a Neutron Activation Analysis (NAA) of the test samples including stages of irradiation by the irradiator and detection by a detector. For a given test sample of the multiple test samples, the mechanism automates (i) tracking of identification of the given sample, and (ii) as generated by the different stages of the NAA, attributing to the given sample physical characteristics and NAA spectra parameters such that the mechanism enables output of an indication of elemental composition of the given sample determined by the NAA of the given test sample. The mechanism is communicatively couple-able to an output interface configured to provide indications of concentration of elements in respective elemental composition of test samples determined by the NAA of the multiple test samples.

In an embodiment, the mechanism is further configured to enable output indications of respective gamma spectrum for test samples.

In another embodiment, the output indications are void of protected personally identifiable information, the mechanism applying anonymization or equivalent techniques to the output data and indications.

In a further embodiment, the output indications include information useful for a determination of activity relating to a donor of one of the multiple test samples.

In an embodiment, the mechanism is further configured to time-stamp the multiple test samples at the different stages of the NAA.

In an embodiment, the neutron source comprises one or more isotopes configured to produce neutrons by at least one of a direct radioactive decay mechanism (such as spontaneous fission), or at least one isotope configured to induce a separate at least one isotope to emit neutrons by a radioactive decay mechanism (such as (n,2n) neutron multiplication).

In embodiments, the neutron source is Californium isotope ²⁵²Cf.

Other configurations, geometries, dimensions, and materials are suitable and in the purview of one skilled in the art given this disclosure. As used herein, the term “high neutron moderation” materials means materials providing relatively high neutron lethargy (that is, speed reduction of fast neutrons to only minimal kinetic energy) and comprising elements with low atomic number (≤ 12), for non-limiting example oxygen, nitrogen, magnesium, oxides, etc. The terms “high neutron moderation” and “relatively high neutron moderation” are used interchangeably. The term “high neutron absorption” materials means relatively high neutron absorption materials having a microscopic cross section of larger than 20 barns (effective over the thermal neutron flux range). A shielding layer resulting from the combination of such high neutron absorption materials and high neutron moderation materials has effective attenuating properties including a mass attenuation coefficient of at least about 0.04cm²/g for thermal neutrons.

As used herein, the term “high density moderation” materials means relatively high density such as in the range 1.2g/cm³ and higher. A moderator layer resulting from the combination of such high neutron moderation materials and high-density moderation materials comprises low atomic number (≤ 12) elements such as carbon, hydrogen, oxygen, and or magnesium. In one embodiment, the moderator layer has effective moderating properties of typical high-density hydrocarbons, such as high-density polyethylene (HDPE) or polyvinyl chloride (PVC) combined with an effective absorber such as boron carbide (B₄C), hafnium, or gadolinium. These are non-limiting examples.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a flow diagram of a Neutron Activation Analysis (NAA) method and system embodying the present invention.

FIGS. 2A and 2B are longitudinal cross section views of ²⁵²Cf-based neutron irradiators embodying the present invention.

FIG. 3 is a table of BCM shielding thickness and respective radioactive dosing rates of four simulated ²⁵²Cf-based neutron irradiator configurations.

FIG. 4 is a graph of BCM shielding thickness versus dose rate of the three thickest shielding configurations of FIG. 3.

FIGS. 5A – 5D are data plots illustrating the log-scale distribution of total neutron flux and thermal flux as a function of distance (in cm) from the vicinity of the ²⁵²Cf source.

### DETAILED DESCRIPTION

A description of example embodiments follows.

Embodiments disclosed herein relate to the neutron and gamma dose rates around a ²⁵²Cf-based neutron irradiator, focusing on areas where individuals are typically present. In their approach, Applicants utilized Monte Carlo N-Particle (MCNP) simulations to assess four different configurations aimed at optimizing safety and operational efficiency. A californium isotope (²⁵²Cf) source emitting 5.77 × 10⁷ neutrons per second was utilized. Applicants conducted preliminary simulations to determine optimal shielding configurations that comply with established radiation exposure limits. Additionally, Applicants evaluated the distribution of neutron fluxes in the vicinity of the ²⁵²Cf source to inform effective shielding strategies. Furthermore, Applicants determined practical applications by estimating measurement times required for gamma spectrometry using high-purity germanium detectors. The overarching goal of Applicant's approach and embodiments is to ensure safe and efficient utilization of a ²⁵²Cf-based neutron irradiator for neutron activation analysis, emphasizing the importance of radiation safety while enabling accurate and reliable measurements for scientific investigations.

Embodiments of the present invention address the limitations of existing neutron irradiators by offering improved precision, efficiency, and safety in Neutron Activation Analysis (NAA). Although NAA has been used since the 1960s, the applications are limited since they require stable neutron sources such as nuclear reactors. Embodiments provide a more reliable method for inducing nuclear reactions in target materials, enhancing the accuracy of analytical results.

The principle of NAA is to irradiate samples in a flux of neutrons. The capture of a neutron by a sample nucleus creates artificial radioisotopes of the elements present in the sample. Following irradiation, the artificial radioisotopes decay with the emission of particles and, of most importance to this disclosure, associated gamma ray characteristics of the element from which they were emitted. These radioisotopes can be measured using a high-purity germanium detector or a sodium iodide (NaI(Tl)) scintillation detector by gamma spectrometry. The induced activity is subsequently determined, and through gamma ray spectrum measured values it is possible to obtain the concentration of the element(s) of interest.

Embodiments put forth a novel, fully automated NAA facility designed to simultaneously achieve multiple objectives. The first objective relates to a computer-optimized design of a polymeric shield and neutron moderation of a 4*pi emitting neutron source, designed to accommodate a maximum number of simultaneous irradiation specimens in a radially symmetric geometry for automated pick-and-place insertion and removal for maximum neutron utilization and minimum residence time. The second objective relates to optimized neutron shielding to ensure that a remote operator does not incur a dangerous amount of radiation dose while working daily near the instrument. The third objective relates to a system to automatically weigh and mark specimen-vial combinations in a computer database for tracking of sample characteristics and parameters to corresponding NAA spectra, including the method of data representation combining all of this data. The fourth objective relates to a feedback algorithm to determine, using online gamma spectra, when an appropriate signal-to-noise ratio (SNR) for a specific specimen has been reached based on a pre-determined threshold of an adequate SNR.

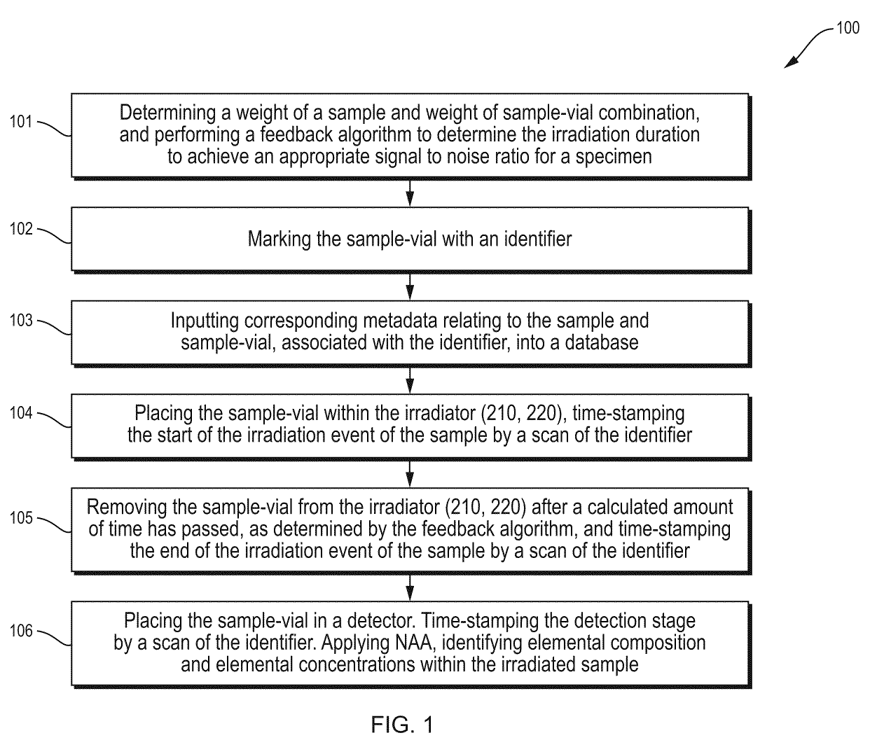

FIG. 1 is a flow chart of a method and system 100 for performing NAA in a ²⁵²Cf-Based Neutron Irradiator, according to principles of the present invention. The method/system begins at step 101, by determining a weight of a sample and weight of the sample-vial combination. Continuing, step 101 performs a feedback algorithm to determine the irradiation duration to achieve an appropriate SNR for the sample (a specific specimen). Techniques known in the art to calculate or otherwise determine desired irradiation duration may be utilized.

Next, at step 102, the sample-vial combination is marked with an identifier. This identifier may be a quick response (QR) code, a radio-frequency-identifier (RFID), a bar code, or any similar suitable means of identification capable of being scanned and providing metadata. The identifier holds metadata relating to the sample and which is input into a computer database system at step 103. This metadata may contain sample donor information or sample source information, physical measurements or details of the sample (total mass, volume, piece counts, etc.), geographic coordinates relating to the origin of the sample, or any other similar relevant characteristics.

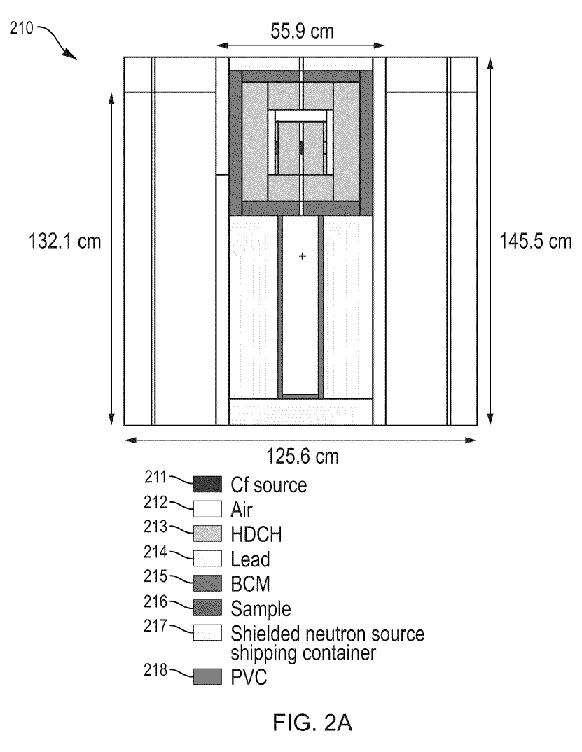

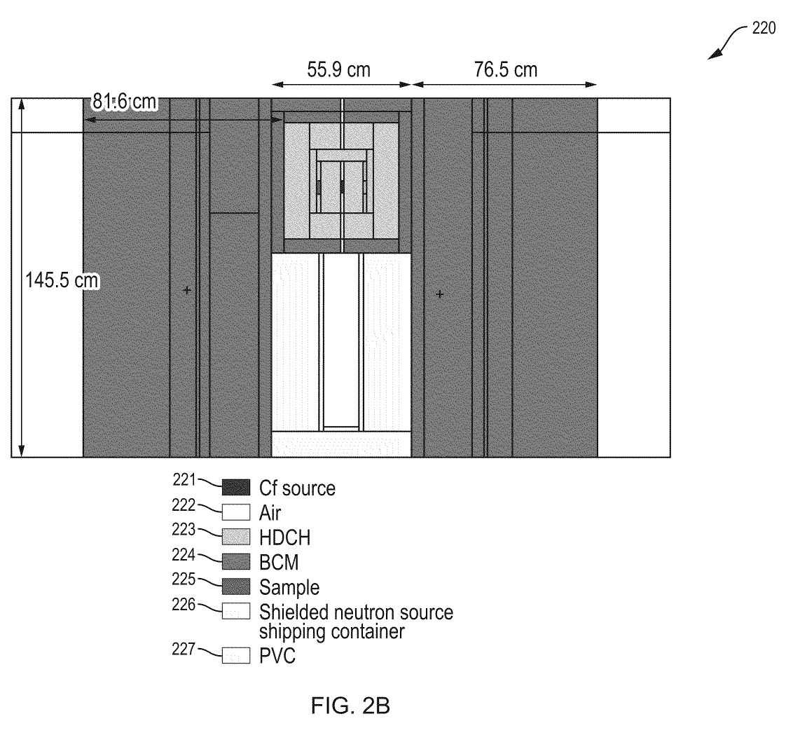

Importantly, the identifier also contains time-stamp information. Once the sample-vial is placed into the irradiator 210 or 220 (of FIGS. 2A and 2B further detailed below) at step 104, the sample-vial’s identifier is scanned and a time-stamp is recorded. The scanning tells the system 100 and the corresponding database record at precisely what date and time that particular sample has begun irradiation, and at what time to take the sample out of the irradiator 210, 220 according to the duration period (length of time) determined by step 101. When it is time to take the sample out of the irradiator 210, 220, the sample-vial is removed at step 105 and the sample-vial is once again scanned and time-stamped in transition to a detector. Removal from irradiator 210, 220 and placement in a detector may be by manual means, mechanical means, or other suitable handling methods and mechanisms.

Finally, at step 106, the detector measures the total elemental concentrations within the irradiated sample. This may be measured using a high-purity germanium detector or a NaI(Tl) scintillation detector by gamma spectrometry. In some embodiments, the measured elemental concentrations may be recorded in and presented via the aforementioned database. In an embodiment, the database system includes an anonymization software in order to protect output of personally identifiable information of the donors of the samples.

It is understood that multiple prepared (weighed, labeled with an identifier, etc. of steps 101 through 103) sample-vials may be irradiated simultaneously in irradiator 210, 220 at steps 104, 105, and subsequently placed in the detector at step 106. In embodiments, about five or more sample-vials may be handled in a same irradiation-detection cycle or event. In this way, system 100 provides high-throughput NAA. Similarly, steps 101, 102, 103, 104, 105, and 106 of system 100, or portions thereof, may be initiated, implemented, or otherwise performed by robot-assisted means, mechanical means, automated means (such as human interfaced computer processors, programmed machines, etc.), and combinations thereof.

Fission reactors and spontaneous fission isotope sources are historically the main tools for conducting NAA. Reactors are extremely expensive, prone to hard-to-maintain issues, and present numerous safety concerns despite their significantly higher neutron flux, and therefore are not amenable to the facile automation of high-throughput NAA. Spontaneous fission isotope sources, whether by single isotopes such as ²⁵²Cf or combinations of isotopes such as Americium-Beryllium (AmBe) or Plutonium-Beryllium (PuBe) to boost low spontaneous fission rates with (n,2n) reactions in Beryllium (Be) represent a potentially faster route to lower the cost and time of NAA. However, a survey to date reveals no dedicated facility in the art designed to conduct high-throughput NAA measurements of adequate sensitivity without a reactor. This is due to simultaneous challenges of the need for more neutrons to boost signal strength, and the need for lower source strength for safety and equipment maintenance concerns.

The present invention features of the ²⁵²Cf Neutron Irradiator embodiments 210, 220 illustrated in FIGS. 2A, 2B include advanced shielding mechanisms, precise control over neutron flux, and a robust structural design (including top-loading access in some embodiments). The benefits include increased accuracy in Neutron Activation Analysis, reduced exposure to radiation for operators, and enhanced overall safety in handling radioactive materials. Rigorous safety protocols are imperative to mitigate potential risks associated with radiation exposure and ensure the protection of researchers and the environment.

The ²⁵²Cf -based neutron irradiator 210, 220 in embodiments is generally cylindrical in shape and has a neutron source 211, 221 at the center, surrounded by a moderator 213, 223 and shielding 214, 215, 224. One of ordinary skill in the art should appreciate that other geometrical entities (i.e., shapes or geometries) beyond a cylinder may be appropriate for particular applications of embodiments. The moderator 213, 223 is primarily fabricated from high neutron moderation materials and high-density moderation materials, i.e., a High-Density Carbon/Hydrogen-based compound (HDCH) material, while the shielding 214, 215, 224 material is made of lead or boron-contained material (BCM) with high neutron absorption capacity. It should be understood that HDCH refers to any material having a high neutron moderating power with the elements with low atomic numbers (i.e., lower than magnesium), and high-density moderation materials higher than 1.2g/cm³.

For non-limiting example, in one embodiment the moderator 213, 223 is fabricated from HDPE High Density Polyethylene. The shielding 214, 215, 224 includes a layer of lead and a BCM layer comprising 50% Boron Carbide (B₄C) and 50% Polyvinyl Chloride (PVC). Other relatively high neutron absorption materials, relatively high neutron moderation materials, and relatively high-density moderation materials, and combinations thereof are suitable.

Materials were meticulously selected with the goal of minimizing the generation of unnecessary long-lived activation products, thereby reducing potential radioactive waste. Notably, even screws may be crafted from plastic. As previously mentioned, in embodiments access to the internal upper planar surface for holding sample-vials to be irradiated is through or near the top of the cylindrical shaped irradiator 210, 220.

Applicants conducted simulations using Monte Carlo N-Particle (MCNP6), a radiation-transport code system, in order to evaluate the neutron and gamma dose rate values at the outer layer position of a ²⁵²Cf-based neutron irradiator (such as 210 and 220), as this location corresponds to where individuals may be present; as well as the thermal, epithermal and fast neutron flux distribution near the ²⁵²Cf source.

The total dose rate values (gamma + neutron) were compared with the dose limit for the public (5x10⁻⁵ Roentgen equivalent man (rem) per hour (h) (rem/h)) and for workers (5x10⁻⁴ rem/h). A hallway frequented by the general public, positioned behind the irradiation station and extending to the area in front, above, and on the sides of the station, which is situated in the laboratory through which workers pass were evaluated. A 30 centimeter (cm) thick outer layer of air was considered.

A scalable ²⁵²Cf-Based Neutron Irradiator, as per an embodiment, is specifically designed for automated, high-throughput NAA. The ²⁵²Cf suitable irradiation facility emits neutrons through spontaneous fission, inducing nuclear reactions in the target materials for analysis, through its high neutron yield. Of particular emphasis is the sufficient shielding for health protection and the moderation material for adjusting neutron speeds, while maintaining the operational feasibility, minimizing the space requirement.

In addition, embodiments teach away from current and prior art designs which are either (1) optimized for reactor-irradiated NAA facilities, (2) built for facile, manual single specimen irradiation, or (3) solutions which do not simultaneously maximize NAA activation, maximize specimen SNR with feedback, minimize irradiation time, and minimize worker dose. The embodiments presented herein facilitate precise Neutron Activation Analysis for elemental composition determination in materials (samples), processing a large number of samples efficiently (e.g., at least 4 or 5 sample- vials simultaneously) at lower cost and with improved safety.

In a non-limiting example, the disclosed ²⁵²Cf-Based Neutron Irradiator NAA system 100 measures heavy metal concentrations in small subject samples such as toenails samples. The heavy metal concentration of interest, for this non-limiting example, is the concentration of arsenic⁷⁵ (⁷⁵As). Heavy metal contamination is a major environmental concern; particularly with renewed interests in mining for batteries, renewable energy sources, and electronics. Toenail samples are known to retain the signals of heavy metal exposure for months, while blood samples only show the exposure of the past few weeks. Therefore, Applicant's design has the capability to greatly simplify the mass testing of workers of relevant occupations (welders, metal workers, miners, environmental remediators) and rendering a normally blood-drawing test far less invasive. The neutron irradiator NAA system 100 also can be used to detect potential contamination as well as anomalies in environmental, geological, biological samples, among others. Further, steps 101, 102, 103, 104, 105, and 106 of system 100, or portions thereof, may be initiated, implemented, or otherwise performed by robot-assisted means, mechanical means, automated means (such as human interfaced computer processors, programmed machines, etc.), and combinations thereof.

Neutrons play a crucial role in diverse applications, employing techniques such as NAA [1]. The Monte Carlo N-Particle (MCNP) has been extensively used for the analysis of physics experiments and reactor designs, as well as for the design of nuclear safeguards, nondestructive assay systems, radiation shields, and nuclear instrumentation [2].

The unique properties of ²⁵²Cf can be used to induce nuclear reactions through its high neutron yield [3, 4]. Activation products can be measured using a high-purity germanium detector or a NaI(Tl) scintillation detector by gamma spectrometry. However, rigorous safety protocols are imperative to mitigate potential risks associated with radiation exposure and ensure the protection of researchers and the environment [5].

Applicants assessed the neutron and gamma dose rates at the outer layer position of a ²⁵²Cf-based neutron irradiator, as this location corresponds to where individuals may be present. Applicants considered a ²⁵²Cf source with a mass of 25 micro-grams (μg) and an activity of 500 mega-Becquerel (MBq) (13.4 milliCuries (mCi)), emitting 5.77 ×10⁷ neutrons per second. Applicants simulated four different configurations using MCNP6, to choose the most effective geometry. Applicants compared the simulation results with the dose limits for the public (5×10⁻⁵ rem/h) and workers (5×10⁻⁴ rem/h) [5 – 8]. The objective is to have sufficient shielding, while maintaining the operational feasibility and minimizing the space requirement.

In addition, Applicants evaluated the distribution of the total and thermal neutron fluxes (cm⁻² seconds⁻¹ (s)) for the vicinity of the ²⁵²Cf source. Calculations were performed for a hypothetical six days irradiation of a four grams sample of Standard Reference Material 1633b (Coal Fly Ash) [9] to determine the required measurement time in a high-purity Germanium (HPGe) detector for achieving 40,000.00 counts at the gamma energy of 559.101 kiloelectron vols (keV) for arsenic-76 (⁷⁶As). The goal is to ascertain the concentration of ⁷⁵As in toenail samples utilizing this neutron irradiator.

Applicants conducted the simulations using MCNP6, with a cylindrical geometry for all structures. The diameter of these cylinders aligns with the actual thickness of the corresponding material such as shown in FIGS. 2A and 2B for purposes of illustration and not limitation.

In the first configuration, Applicants incorporate 5.1 cm thick lead bricks, a 1 cm thick lead chamber and a 11 cm thick outer layer of air. The chosen procedure for sample loading/unloading originated from the front (near the top of a side wall) of the irradiator. This configuration is the minimal shielding among the four different designs considered. A commercially available shielded neutron source shipping container, and a sample to be irradiated by neutrons are also implemented (see FIG. 2A).

Specifically, FIG. 2A shows a longitudinal cross section of the first irradiator 210 configuration made in the MCNP6 simulations. The housing of the irradiator 210 is formed of walls comprising at least two layers of shielding (214, 215) and one moderator layer (213), such that the walls effectively minimize radiation exposure external to the housing. The two layers of shielding may be the outermost layers of the housing walls, the first (outermost shielding) layer being formed of lead 214 and the second (inner shielding) layer being formed of BCM 215. The combined thickness between the inner and outer diameters of each of the first and second shielding layers 214, 215 may be about five to seven centimeters. The BCM shielding layer may have an inner diameter of about 5cm – 150cm, for non-limiting example 45cm – 46cm, and a thickness between the inner diameter and an outer diameter of at least about 18cm – 59cm (in various embodiments, with or without the outermost lead shielding layer). Additionally, the moderator layer 213 includes High-Density Carbon/Hydrogen (HDCH) and is configured to constrain the multiple test samples 216. The housing contains a neutron source 211, i.e., a ²⁵²Cf source, positioned within the housing in a manner that provides simultaneous irradiation of multiple test samples 216. The multiple test samples 216 may be positioned in a radially symmetric geometry in relation to the neutron source 211, enabling maximum neutron utilization and minimum residence time for high throughput NAA.

Still referring to FIG. 2A, a shielded neutron source shipping container is located coaxially within the housing and contains the neutron source 211. The commercially available shielded neutron source shipping container may have a first (or outer) cylindrical layer 217 formed of a combination of relatively low neutron absorption and relatively high neutron moderation materials (such as water extended polyester or WEP, for non-limiting example), and a coaxial second (or inner) cylindrical layer formed of, polyvinyl chloride (PVC) 218. The first cylindrical layer 217 is concentric to the second cylindrical layer 218 such that a cross section of an outer diameter of the second cylindrical layer directly abuts an inner diameter of the first cylindrical layer. The second cylindrical layer also constrains a volume of air 212.

The second, third and fourth configurations are similar to the above description. However, a 30 cm thick outer layer of air external to the irradiator housing was considered. In addition, instead of the previous front-loading design, embodiments opt for a top-loading approach. The thickness of the HDCH moderator structure 223 remained constant in these configurations, whereas the thickness of BCM shielding 224 was varied.

In the fourth configuration, a BCM shielding layer 224 having thickness of 81.6 cm is shown in FIG. 2B. The increased BCM layer 224 thickness is for radiation protection purposes; particularly for the general public and people walking in the hallway in the location an embodiment may be implemented.

In FIG. 2B, a longitudinal cross section of the fourth configuration 220 in the MCNP6 simulation is shown. As noted above, this configuration includes a BCM shielding layer 224 thickness of about 80 cm. Similar to the irradiator 210 configuration shown in FIG. 2A, the FIG. 2B configuration provides an irradiator 220 with a housing comprising multi-layer walls. However, in the FIG. 2B configuration the housing walls do not include a layer of lead. On the other hand, similar to irradiator configuration 210, irradiator configuration 220 includes the moderator layer 223 comprised of High-Density Carbon/Hydrogen (HDCH) and configured to constrain the multiple test samples 225. The housing contains a neutron source 221, i.e., a ²⁵²Cf source, positioned within the housing in a manner that provides simultaneous irradiation of multiple test samples 225. The multiple test samples 225 may be positioned in a radially symmetric geometry in relation to the neutron source 221, enabling maximum neutron utilization and minimum residence time for high throughput NAA.

Still referring to FIG. 2B, a commercially available shielded neutron source shipping container is located within the housing and contains the neutron source 221. The commercially available shielded neutron source shipping container may have a first or outer cylindrical layer 226 (such as that formed of WEP or equivalent described in FIG. 2A), and a second or inner cylindrical layer formed of, for non-limiting example, PVC 227. The second cylindrical layer also constrains a volume of air 222.

Simulations were performed for the four configurations. The obtained total dose rate values from the simulations were compared with 5×10⁻⁵ rem/h (the dose limit for the public) and with 5×10⁻⁴ rem/h (the dose limit for workers), for the thick outer layer of air region. The total dose rate is defined as the combined sum of the gamma and neutron dose rates.

The total dose rate is designed to be below the specified limit for workers, within the laboratory premises [5, 6]. On the other hand, the total dose rate in a hypothetical hallway outside the laboratory should comply with the predefined limit for public exposure [7].

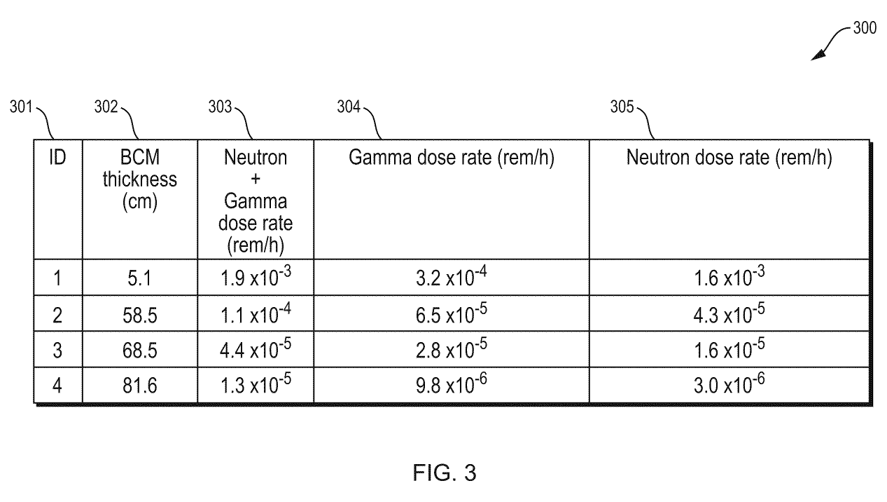

FIG. 3 shows Table 300, which compares the BCM (shielding layer) thickness 302, the total dose rate 303, as well as the individual gamma dose rate 304 and neutron dose rate 305 for the four different configurations 301 disclosed above. In Table 300, the total dose rate 303, which is the gamma dose rate 304 plus neutron dose rate 305, is a function of the BCM shielding layer thickness values 302. The first configuration (ID 1 and corresponding to irradiator 210 of FIG. 2A)) is notably distinctly different from the remaining three configurations (IDs 2-4).

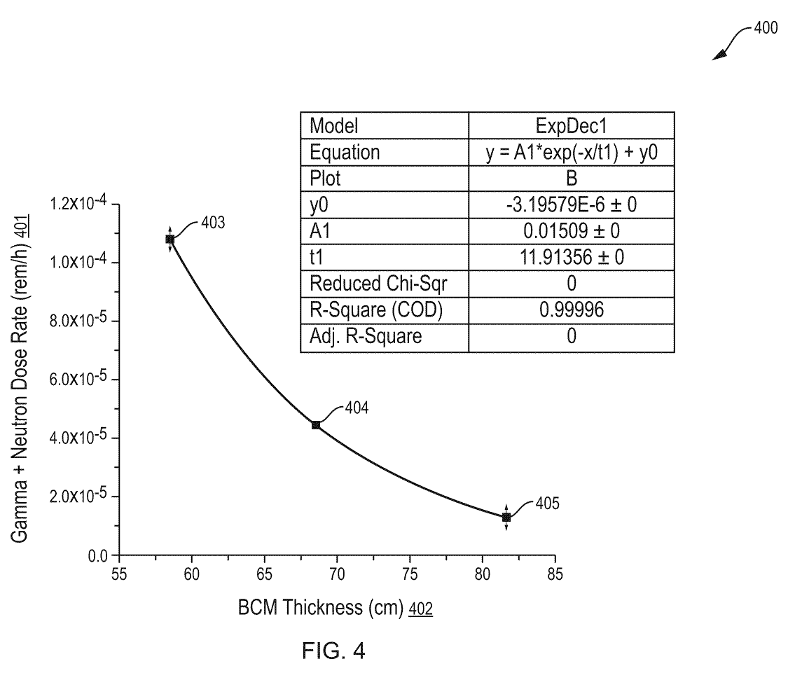

FIG. 4 shows a graph 400 comparing the BCM thickness 402 vs (Gamma + Neutron) Dose Rate 401 that was evaluated for the second configuration 403 (58.5 cm), third configuration 404 (68.5 cm), and fourth configuration 405 (81.6 cm), of irradiators discussed above. The subject irradiators have similar geometry differing only by the BCM shielding layer 224 thickness. The analysis reveals an exponential fit for the data as illustrated in the graph 400 of FIG. 4.

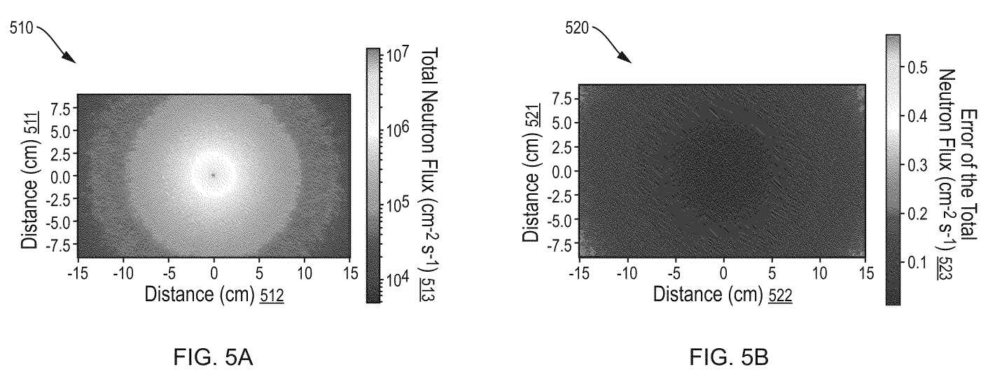

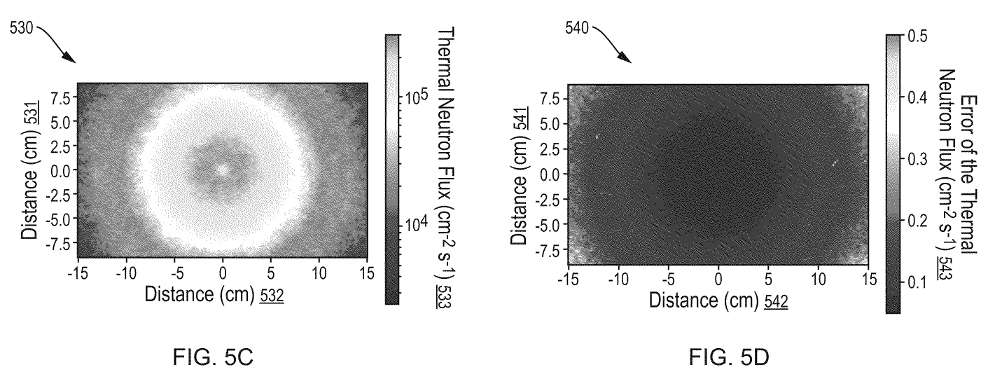

FIGS. 5A – 5C show plots 510, 520, 530 and 540, respectively, representing the distribution of the total and thermal neutron fluxes (cm⁻² s⁻¹) as a function of distance (in cm) from the vicinity of the ²⁵²Cf source. The distribution in log scale for the vicinity (distance in cm) of the ²⁵²Cf source are shown respectively in plots 510 (FIG. 5A) and plot 530 (FIG. 5C), while the corresponding error plots for these distributions are depicted in 520 (FIG. 5B) and 540 (FIG. 5D).

That is, FIG. 5A shows plot 510 which illustrates the log-scaled distribution of total neutron flux 513 (cm⁻² s⁻¹) as a function of the distance (in cm) from the vicinity of the ²⁵²Cf source. Plot 510 shows distance (in cm) on both axis 511 and 512.

FIG. 5B shows plot 520 which illustrates the logarithmically scaled error in the distribution of total neutron flux 523 (cm⁻² s⁻¹) as a function of the distance (in cm) from the vicinity of the ²⁵²Cf source. Plot 520 shows distance (in cm) on both axis 521 and 522.

FIG. 5C shows plot 530 which illustrates the log-scaled distribution of thermal neutron flux 533 (cm⁻² s⁻¹) as a function of the distance (in cm) from the vicinity of the ²⁵²Cf source. Plot 530 shows distance (in cm) on both axis 531 and 532.

FIG. 5D shows plot 540 which illustrates the logarithmically scaled error in the distribution of thermal neutron flux 543 (cm⁻² s⁻¹) as a function of the distance (in cm) from the vicinity of the ²⁵²Cf source. Plot 540 shows distance (in cm) on both axis 541 and 542.

At a distance of 5 cm from the ²⁵²Cf source, a thermal neutron flux on the order of 105 cm⁻² s⁻¹, was observed as illustrated in FIG. 5C.

Applicants determined that for a hypothetical 6 days irradiation of a 4 grams sample of Coal Fly Ash in a thermal neutron flux of 105 cm⁻² s⁻¹, the required measurement time in a HPGE detector for achieving 40,000.00 counts at the gamma energy of 559.101 keV for ⁷⁶As is 2.6 days, a practicable counting time with a reasonable counting statistic.

In conclusion, embodiments demonstrate that the total dose rate remains below the established limit for workers (5 ×10⁻⁴ rem/h) when the BCM shielding 224 thickness is 58.5 cm (second configuration). Moreover, if the thicknesses of the BCM shielding is 68.5 cm and 81.6 cm (third and fourth configurations), the computed total dose rate values fall below the public dose limit of 5 ×10⁻⁵ rem/h.

The total dose rate for the first configuration surpasses the prescribed limits for both public and worker exposure.

Therefore, a neutron irradiator with a minimum thickness of 68.5 cm of BCM for the shielding layer 224 (third configuration) ensures a total dose rate below the established limit for the public, so the 30 cm thick outer layer of air in this configuration can be designated as an allowed space for the general public.

Simultaneously, a minimum thickness of 58.5 cm of BCM shielding layer 224 (second configuration) guarantees a total dose rate below the prescribed limit for workers, so the 30 cm thick outer layer of air in this configuration can be designated as an allowed space for workers.

The ²⁵²Cf-Based Neutron Irradiator analyzed by this study offers a viable means to conduct Neutron Activation Analysis within a practical counting time frame, ensuring statistically meaningful results at the gamma energy of 559.101 keV for ⁷⁶As and radiation protection for the researchers and the environment. Hence, the utilization of the ²⁵²Cf-based neutron irradiator 210, 220 in system 100 provides the necessary conditions for the precise determination of ⁷⁵As concentration in toenail samples. Other target samples are suitable and in the purview of one skilled in the art given this disclosure. As previously noted, steps 101, 102, 103, 104, 105, and 106 of system 100, or portions thereof, may be initiated, implemented, or otherwise performed by robot-assisted means, mechanical means, automated means (such as human interfaced computer processors, programmed machines, etc.), and combinations thereof.

### References

[1] IAEA-TECDOC-1215, "Use of research reactors for neutron activation analysis”, Vienna (2001).
[2] J. A. KULESZA, et al. “MCNP® Code Version 6.3.0 Theory & User Manual,” Los Alamos National Laboratory Tech. Rep., Los Alamos (2022).
[3] J. HOSTE, “Isotopic Neutron Sources for Neutron Activation Analysis”, IAEA-TECDOC-465, Vienna (1988).
[4] B. C. ANDERSON, K. E. HOLBERT and H. BOWLER, “Design, Construction, and Modeling of a 252Cf Neutron Irradiator,” Science and Technology of Nuclear Installations, Hindawi, 2016, ID 9012747, 12 (2016).
[5] IAEA Safety Standards Series No. GSG-7. Occupational Radiation Protection, General Safety Guide, Vienna (2018).
[6] Information for Radiation Workers. https://www.nrc.gov/about-nrc/radiation/health-effects/info.html#dose
[7] Subpart D ˗ Radiation Dose Limits for Individual Members of the Public. https://www.nrc.gov/reading-rm/doc-collections/cfr/part020/part020-1301.html
[8] 105 CMR 120: The control of radiation. Trial Court Law Libraries, Massachusetts Court System (2022). https://www.mass.gov/doc/105-cmr-120-the-control-of-radiation-0/download [9] Material Database ˗ Certified Reference Material. SRM 1633b ˗ Constituent Elements in Coal Fly Ash. NIST ˗ National Institute of Standards and Technology. https://speciation.net/Database/Materials/National-Institute-of-Standards-and-Technology-NIST/SRM-1633b--Constituent-Elements-in-Coal-Fly-Ash-;i784

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A radioactive decay-based neutron irradiation measurement system comprising:
an irradiator, the irradiator having a housing formed of walls comprising at least one layer of shielding and a moderator, such that the walls effectively minimize radiation exposure external to the housing, the housing containing a neutron source, the neutron source being positioned within the housing in a manner providing simultaneous irradiation of multiple test samples;
a mechanism that automates association of the test samples with respective data from each of different stages of a Neutron Activation Analysis (NAA) of the test samples including stages of irradiation by the irradiator and detection by a detector, for a given test sample of the multiple test samples, the mechanism automates (i) tracking of identification of the given sample, and (ii) as generated by the different stages of the NAA, attributing to the given sample physical characteristics and NAA spectra parameters such that the mechanism enables output of an indication of elemental composition of the given sample determined by the NAA of the given test sample; and
an output interface communicatively coupled to the mechanism and providing indications of concentration of elements in respective elemental composition of test samples determined by the NAA of the multiple test samples.

2. The system of claim 1, wherein: the irradiator is top loading, and the housing is a relatively cylindrical container wherein:
(i) the at least one layer of shielding is formed of a combination of high neutron absorption and high neutron moderation materials (BCM) and has an inner diameter of about 5cm – 150cm, the at least one layer of shielding having a thickness between the inner diameter and an outer diameter of at least about 18cm – 59cm; and
(ii) the moderator is formed of a combination of high neutron moderation materials and high-density moderation materials.

3. The system of claim 2, further comprising a shielded neutron source shipping container located within the housing and containing the neutron source, the shielded neutron source shipping container having walls formed of:
a first relatively cylindrical layer formed of a combination of low neutron absorption and high neutron moderation materials; and
a second relatively cylindrical layer formed of polyvinyl chloride, the first cylindrical layer being concentric to the second relatively cylindrical layer such that in cross section an outer diameter of the second relatively cylindrical layer directly abuts an inner diameter of the first relatively cylindrical layer, and an inner diameter of the second relatively cylindrical layer constrains a volume of air.

4. The system of claim 1, further comprising a port for loading the multiple test samples into the housing, the port being located atop the housing.

5. The system of claim 1, wherein the multiple test samples are in a radially symmetric geometry in relation to the neutron source, the geometry enabling maximum neutron utilization and minimum residence time for high throughput NAA.

6. The system of claim 1, wherein the mechanism further enables output indications of respective gamma spectrum for test samples.

7. The system of claim 6, wherein the output indications are void of protected personally identifiable information.

8. The system of claim 6, wherein the output indications include information useful for determining activity relating to a donor of one of the multiple test samples.

9. The system of claim 1, wherein the mechanism includes time-stamping the multiple test samples at the different stages of the NAA.

10. The system of claim 1, further comprising a feedback algorithm, using online gamma spectra, configured to determine when an appropriate signal to noise ratio for each of the multiple test samples has been achieved.

11. The system of claim 1, wherein the neutron source comprises one or more isotopes configured to produce neutrons by at least one of a direct radioactive decay mechanism, or at least one isotope configured to induce a separate at least one isotope to emit neutrons by a radioactive decay mechanism.

12. The system of claim 1, wherein the neutron source is Californium isotope ²⁵²Cf.

13. A radioactive decay-based neutron irradiator apparatus comprising:
a relatively cylindrical housing formed of walls containing a neutron source, the neutron source being positioned within the relatively cylindrical housing in a manner providing simultaneous irradiation of multiple test samples, the walls of the relatively cylindrical housing effectively minimize radiation exposure external to the housing, the walls comprising:
(i) at least one layer of shielding formed of a combination of high neutron absorption and high neutron moderation materials (BCM) and having an inner diameter of about 5cm – 150cm, the at least one layer of shielding having a thickness between the inner diameter and an outer diameter of at least about 18cm – 59cm; and
(ii) a moderator formed of a combination of high neutron moderation materials and high-density moderation materials; and
a shielded neutron source shipping container having walls formed of:
(i) a first relatively cylindrical layer formed of a combination of low neutron absorption and high neutron moderation materials; and
(ii) a second relatively cylindrical layer formed of polyvinyl chloride, the first relatively cylindrical layer being concentric to the second relatively cylindrical layer such that in cross section an outer diameter of the second relatively cylindrical layer directly abuts an inner diameter of the first relatively cylindrical layer, and an inner diameter of the second relatively cylindrical layer constrains a volume of air.

14. The apparatus of claim 13, further comprising a port for loading the multiple test samples into the housing, the port being located atop the housing.

15. The apparatus of claim 13, wherein the multiple test samples are in effectively a radially symmetric geometry in relation to the neutron source, the geometry configured to enable maximum neutron utilization and minimum residence time for high throughput NAA.

16. The apparatus of claim 13, wherein the multiple test samples are prepared with
a mechanism that automates association of the test samples with respective data from each of different stages of a Neutron Activation Analysis (NAA) of the test samples including stages of irradiation by the irradiator and detection by a detector, for a given test sample of the multiple test samples, the mechanism automates (i) tracking of identification of the given sample, and (ii) as generated by the different stages of the NAA, attributing to the given sample physical characteristics and NAA spectra parameters such that the mechanism enables output of an indication of elemental composition of the given sample determined by the NAA of the given test sample; and
the mechanism communicatively couple-able to an output interface configured to provide indications of concentration of elements in respective elemental composition of test samples determined by the NAA of the multiple test samples.

17. The apparatus of claim 16, wherein the mechanism is further configured to enable output indications of respective gamma spectrum for test samples.

18. The apparatus of claim 17, wherein the output indications are void of protected personally identifiable information.

19. The apparatus of claim 17, wherein the output indications include information useful for a determination of activity relating to a donor of one of the multiple test samples.

20. The apparatus of claim 16, wherein the mechanism is further configured to time-stamp the multiple test samples at the different stages of the NAA.

21. The system of claim 13, wherein the neutron source comprises one or more isotopes configured to produce neutrons by at least one of a direct radioactive decay mechanism, or at least one isotope configured to induce a separate at least one isotope to emit neutrons by a radioactive decay mechanism.

22. The apparatus of claim 13, wherein the neutron source is Californium isotope ²⁵² Cf.
